(19) United States
(12) Patent Application Publication
(10) Pub. No.: US 2023/0176607 A1
(43) Pub. Date: Jun. 8, 2023

(54) Ising Model Calculation Device

(71) Applicant: Nippon Telegraph and Telephone Corporation, Tokyo (JP)

(72) Inventors: Hiroki Takesue, Musashino-shi, Tokyo (JP); Takahiro Inagaki, Musashino-shi, Tokyo (JP); Toshimori Honjo, Musashino-shi, Tokyo (JP); Kensuke Inaba, Musashino-shi, Tokyo (JP); Yasuhiro Yamada, Musashino-shi, Tokyo (JP); Takuya Ikuta, Musashino-shi, Tokyo (JP)

(21) Appl. No.: 17/920,218

(22) PCT Filed: Apr. 23, 2020
(86) PCT No.: PCT/JP2020/017433

§ 371 Date: Oct. 20, 2022

(51) Int. Cl. G06E 3/00

(52) U.S. Cl. CPC G06E 3/00

(57) ABSTRACT

In an Ising model calculation device for computing a generalized Ising model expressed by a Hamiltonian having a magnetic field term, the magnetic field term is applied to spins simulated by state monitoring light pulses, and a response of the obtained light pulses is determined by fitting to perform state monitoring during application of a magnetic field term.

### TECHNICAL FIELD

The present disclosure relates to a calculation apparatus (Ising machine) that performs calculation based on the Ising model, which is a theoretical model of interacting spin groups such as magnetic bodies.

### BACKGROUND ART

Many important issues in modern society, such as delivery route optimization and radio frequency allocation, are combinatorial optimization problems. Consequently, there is an urgent need to evaluate large-scale optimization problems as fast and accurate as possible.

There is known an Ising model calculation device that pseudo-simulates an Ising model with light pulses by using a laser network. For example, a coherent Ising machine (CIM) has been proposed in which a light pulse train having a state quantity corresponding to spins of sites (lattice points) of an Ising model is time-division multiplexed and caused to circulate in an optical resonator, and the resulting light pulse train is converged by using the interaction as feedback, to solve a combinatorial optimization problem as a problem of searching the ground state of the Ising model.

A subsequent proposal includes using a time division multiplexing using a degenerate optical parametric oscillator (DOPO). According to the proposal, it can be expected to achieve a large-scale configuration having as many as 2000 nodes, for example. (PTL 1 and NPL 1)

In a coherent Ising machine (CIM) using a degenerate optical parametric oscillator (DOPO), spin values are expressed by phases 0 and π of light pulses generated by the DOPO. The spin values of the DOPO pulse group are measured by branching the light pulses within a ring-shaped optical fiber constituting the optical resonator. The feedback is used to cause interactions between the light pulses, and calculation is repeatedly performed until the light pulses converge.

This makes it possible to solve the problem of searching the ground state in the theoretical model (Ising model) of interacting spin groups, which led to the development of a coherent Ising machine (NPL 2).

A Hamiltonian H (energy function of the system) employed in the coherent Ising machine and expressing the interaction between the DOPO light pulses is expressed by Equation (1) below.

Math. 1

H=−Σ_{i,j}Jᵢⱼσᵢσⱼ (1)

Here, σᵢ is the spin at a site i (i being a natural number) and takes a value of {1, −1} in the Ising model and Jij is an inter-spin interaction coefficient between the spin σᵢ and a spin σⱼ. In a coherent Ising machine, the spins σ take positive and negative analog values and are approximately represented by using cosine components cᵢ of amplitudes of light pulses. Absolute values of the cosine components cᵢ of the amplitudes of the light pulses saturate with time evolution when the light pulses circulate.

FIG. 1 is a schematic view of a related art coherent Ising machine using DOPO light pulses. In FIG. 1, 2048 time-division multiplexed DOPO light pulses circulate in an optical resonator 1 composed of an optical fiber loop. The DOPO light pulses are branched by a light branching portion 2, and amplitudes of the branched DOPO light pulses are measured by a balanced homodyne detector 3, as electric signals {c₀, c₁, . . . , c₂₀₄₇} corresponding to the spins.

Furthermore, based on this amplitude measurement, the spins of light pulses being used for the arithmetic operation are measured. The obtained information is used to compute interactions between spins by a field-programmable gate array (FPGA) 4. A modulator 5 adds the obtained signals to light beams and the obtained light beams are fed back from a coupling portion 6 to an optical resonator 1. Calculation using this mechanism is repeated until the light beams converge, to obtain a solution in the Ising machine. It has been reported that this coherent Ising machine can be used to search at high speed for a solution to a combinatorial optimization problem called the maximum cut problem.

When a DOPO is used to implement a coherent Ising machine in the form of Equation (1), the time evolution of the amplitude of the i-th (i being a natural number) DOPO light pulse is approximately described by Equation (1b) below (NPL 2).

$$\begin{matrix}Math . 2 & \\ \frac{d {c}_{i}}{d t} = ( - 1 + p - {c}_{i}^{2} ) {c}_{i} - {\sum }_{j}^{N} {J}_{ij} {c}_{j} & ( 1 b )\end{matrix}$$

Here, p is a pump amplitude normalized at a value at an oscillation threshold value of an independent DOPO light pulse, and cᵢ is a cosine component of the amplitude of the DOPO light pulse normalized at an amplitude value at which p=2. Relating to the characteristics of the DOPO, a sine component of the amplitude is attenuated, and thus, the sine component is ignored.

In the coherent Ising machine described above, the amplitude of the DOPO light pulses fluctuates during oscillation due to the instability of the resonator, and thus, operating conditions vary greatly.

Additionally, the phase instability of local oscillation light for balanced homodyne detection (not illustrated in FIG. 1) and the phase instability of an injection pulse also cause the amplitude of the DOPO light pulse to fluctuate, which is problematic. Furthermore, another problem having the sign of the light pulse coupling inverted, may be inadvertently solved.

Thus, it is necessary to check the quality of the answer obtained by solving the problem. For this purpose, in the related art, light pulses corresponding to a simple, small-scale problem having a known correct answer are added as state monitoring check spins to a part of the light pulses used in the calculation, to solve the simple, small-scale problem simultaneously with a problem to be solved having an unknown correct answer. Subsequently, an answer for the check spins is evaluated by comparing with the known correct answer of the simple problem, to confirm whether the problem to be solved having the unknown correct answer is correctly computed (PTL 2).

The description above relates to a so-called Ising machine with constraints that performs calculation in a limited Ising model in which the Hamiltonian is only composed of an inter-spin interaction term.

On the other hand, in a more generalized Ising model, a term referred to as a magnetic field term is further added to the Hamiltonian of Equation (1) to express the Ising model by a Hamiltonian H of Equation (2) below.

H=Σ_{i,j}Jᵢⱼσᵢσⱼ−Σᵢhᵢσᵢ (2)

Here, similarly to Equation (1), Jᵢⱼ is the inter-spin interaction coefficient, σᵢ is the spin at the site i, and hᵢ is an external magnetic field at the site i added in Equation (2). In the present invention, the external magnetic field is not a physical magnetic field, but a virtual magnetic field acting on the spins at the sites of the Ising model. The external magnetic field is set in accordance with a problem to be solved, including check spins.

The first term on the right side of Equation (2) is the same inter-spin interaction term as in Equation (1), and the second term on the right side of Equation (2) is a magnetic field term from the external magnetic field acting on each spin.

It is known that more various types of combinatorial optimization problems, including the four-color map problem and the traveling salesman problem, can be solved by converting the problem into a generalized Ising model having the Hamiltonian of Equation (2).

### CITATION LIST

### Patent Literature

PTL 1: WO 2017/047666
PTL 2: WO 2019/078354

### Non Patent Literature

NPL 1: Takahiro Inagaki et al., “A coherent Ising machine for 2000-node optimization problems”, SCIENCE, 2016, pp. 603-606, Vol. 354.
NPL 2: Z. Wang et al., “Coherent Ising machine based on degenerate optical parametric oscillators”, Phys. Rev. A 88, 063853 (2013)
NPL 3: Activation function https://ja.wikipedia.org/wiki/% E6% B4% BB % E6%80% A7% E5%8C %96% E9%96% A2% E6%95% B 0

### SUMMARY OF THE INVENTION

### Technical Problem

As described above, Equation (2) of the Hamiltonian expressing the more generalized Ising model is composed of the inter-spin interaction term and the magnetic field term. However, the magnetic field term is not considered in the method of checking the accuracy of a solution in the related art of PTL 2. Thus, it is unfortunately not possible to apply the methods of the related art to a method of checking the accuracy of a solution in the more generalized Ising model composed of the magnetic field term and the inter-spin interaction term.

That is, in computing the generalized Ising model, the Hamiltonian is composed of the magnetic field term and the inter-spin interaction term, and thus, in a method of the related art using only the inter-spin interaction term, it is unfortunately not possible to evaluate whether the magnetic field term is applied to a desired state.

The present invention has been contrived to solve these problems, and an object thereof is to implement an Ising model calculation device capable of checking the accuracy of a solution of a more generalized Ising model composed of a magnetic field term and an inter-spin interaction term.

### Means for Solving the Problem

Examples of embodiments of the present invention include the following configurations to achieve the above object.

In order to solve the problems described above, the present invention is characterized in performing state monitoring during application of a magnetic field term as follows. Light pulses are set as state monitoring check bits for the magnetic field term, and only an external magnetic field term is applied to spins simulated by the state monitoring light pulses, to obtain a response of the obtained pulses by fitting.

Alternatively, in order to solve the problems described above, some of DOPO pulses used in a coherent Ising machine CIM are used as state monitoring light pulses, and only when a state monitoring light pulse simulating the application of the external magnetic field term achieves an appropriate growth as a result of the time evolution in the CIM, a calculation result obtained in the time evolution is adopted.

It is noted that the technique described in PTL 1 also uses state monitoring light pulses, but in this case, interactions between pulses are produced and a problem of a simple Ising model including no magnetic field is solved to check the quality of the solution. The present invention differs from the technique described in PTL 1 in that an Ising model calculation device for computing a generalized Ising model expressed by a Hamiltonian having a magnetic field term is provided, no interactions between pulses are produced, and only the magnetic field term is applied, to observe a state of the magnetic field term after time evolution.

### Configuration 1

An Ising model calculation device for computing a generalized Ising model expressed by a Hamiltonian having a magnetic field term, the Ising model calculation device configured to:

apply a magnetic field to spins of state monitoring light pulses; measure amplitudes of the obtained state monitoring light pulses to monitor a state of the magnetic field term; and monitor an operation state of the Ising model calculation device as a coherent Ising machine.

### Configuration 2

The Ising model calculation device described in Configuration 1, wherein

the magnetic field applied to the state monitoring light pulses is a magnetic field having amplitude values forming a slope dependent on time slots, and the magnetic field is applied so as to cross a zero point of the magnetic field.

### Configuration 3

The Ising model calculation device described in Configuration 1, wherein

the magnetic field applied to the state monitoring light pulses is constant value.

### Configuration 4

The Ising model calculation device described in Configuration 1, wherein

the magnetic field applied to the state monitoring light pulses is proportional to an absolute value of measured amplitudes of the state monitoring light pulses.

### Configuration 5

The Ising model calculation device described in any one of Configurations 1 to 4, further configured to:

fit a specific fitting function to the measured amplitudes of the state monitoring light pulses; and using an obtained value of a fitting parameter, select a calculation result of the Ising model calculation device as a coherent Ising machine.

### Configuration 6

The Ising model calculation device described in any one of Configurations 1 to 4, further configured to:

determine an average amplitude value of the measured amplitudes of the state monitoring light pulses; and using the average amplitude value, select a calculation result of the Ising model calculation device as a coherent Ising machine.

### Configuration 7

A calculation system including the Ising model calculation device described in any one of Configurations 1 to 4.

### Effects of the Invention

Advantageously, the present invention allows for evaluation of whether the magnetic field term is applied to a desired state, in an Ising model calculation device for computing a generalized Ising model composed of a magnetic field term and an inter-spin interaction term.

By using the method of the present invention to screen calculation results of a coherent Ising machine, it is possible to extract calculation results obtained from an operation under appropriate conditions, and thus, a coherent Ising machine calculation system that stably provides good solutions can be achieved.

### BRIEF DESCRIPTION OF DRAWINGS

FIG. 1 is a schematic view of a related art coherent Ising machine.

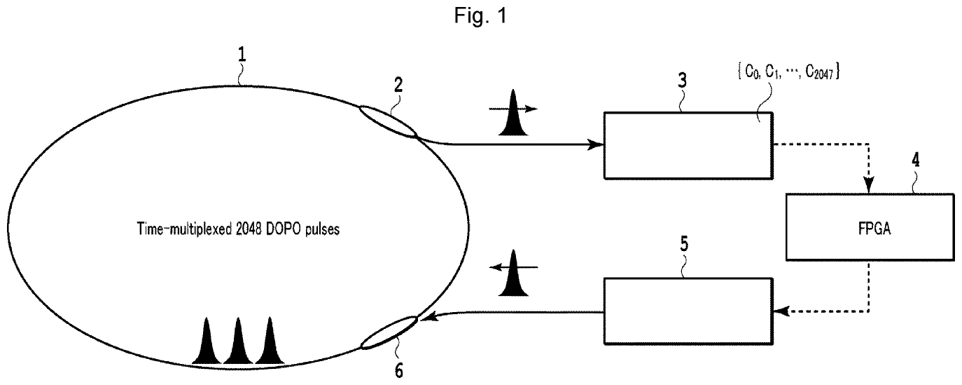

FIG. 2 is a diagram illustrating a pattern of pulses of state monitoring check bits according to a first example.

FIG. 3 is a diagram illustrating other patterns 1 to 3 of pulses of the state monitoring check bits according to the first example.

FIG. 4 is a diagram for explaining a steady-state solution of amplitudes of DOPO light pulses including a magnetic field (in a case where a magnetic field term is proportional to the absolute value of the amplitude), and illustrates a relationship between a magnetic field amplitude B and a normalized pulse amplitude C.

FIG. 5 is a diagram illustrating an input of the magnetic field amplitude B of the pulses of the state monitoring check bits according to the first example, and a simulation result.

FIG. 6 is a diagram of experimental results illustrating an example of a measurement result of amplitudes of the pulses of the magnetic field check bits of the first example.

FIG. 7 is a diagram illustrating an example of a fitting function used in a second example.

FIG. 8 is a diagram illustrating a pattern of pulses of state monitoring check bits according to a third example.

FIG. 9 is a diagram illustrating other patterns 4 to 6 of pulses of the state monitoring check bits according to the third example.

FIG. 10 is a diagram illustrating other patterns 7 to 9 of pulses of the state monitoring check bits according to the third example.

FIG. 11 is a diagram of the pulse amplitudes of pattern 9 of the third example, in which odd-numbered slots and even-numbered slots are combined.

### DESCRIPTION OF EMBODIMENTS

In the present invention, state monitoring during application of a magnetic field term is performed as follows. Light pulses are set as state monitoring check bits for the magnetic field term and only an external magnetic field term is applied to spins simulated by the state monitoring light pulses, to obtain a response of the obtained pulses by fitting.

When the external magnetic field is applied, it is possible to apply magnetic fields having different intensities and directions for each pulse. For example, it is also possible to alternately apply magnetic fields in opposite directions, that is, a magnetic field in a positive direction may be applied to even-numbered pulses in a time slot and a magnetic field in a negative direction may be applied to odd-numbered pulses in the time slot.

The time slot dependence of the magnetic field in the positive direction applied to the even-numbered pulses may be given a negative slope. Furthermore, the time slot dependence of the magnetic field in the negative direction applied to the odd-numbered pulses may be given a positive slope. It is also possible to reverse the odd-numbered pulses and the even-numbered pulses, and the positive direction and the opposite direction of the magnetic field.

Furthermore, if the time slot dependence of the amplitudes of the state monitoring light pulses to which the magnetic field is applied is measured and curves for even-numbered pulses or odd-numbered pulses are fitted with an activation function, it is possible to obtain information about an injection pulse phase.

When the external magnetic field is applied, it is also possible to apply magnetic fields having different intensities and directions for each pulse. The external magnetic field may be applied so that a magnetic field in a positive direction is applied to the first half of pulses in a time slot and a magnetic field in the opposite direction is applied to the latter half of pulses in the time slot. A similar application is possible when the first half and the latter half of pulses are reversed.

When an external magnetic field is applied, it is also possible to apply magnetic fields having different intensities and directions for each pulse. The external magnetic field may be alternately applied, so that the magnetic field is applied to even-numbered pulses in a time slot but is not applied to odd-numbered pulses in the time slot. A similar application is possible when the even numbers and odd numbers are reversed.

Thus, advantageously, in an apparatus for computing an Ising model composed of a magnetic field term and an inter-spin interaction term, it is possible to evaluate whether the magnetic field term is applied to a desired state.

It is possible to check whether the external magnetic field is applied as desired by the following method. For example, amplitudes of light pulses of state monitoring check bits of even-numbered and odd-numbered magnetic field terms in a time slot of time-division light pulses are measured. The measurement data points are fitted by a fitting function, to confirm the following items (1) to (4) in accordance with fitting parameters of the fitting function.

Specifically, the fitting parameters reflect the following four items (1) to (4) and determine these items.

(1) Is the orientation (sign) of the phase of the magnetic field correct?

The sign of saturation amplitude reflects a sign of the injection pulse phase, and the absolute value of the saturation amplitude reflects a state of the DOPO oscillation.

(2) How much does the phase of the magnetic field deviate from 0/π?

The sign of saturation amplitude reflects a sign of the injection pulse phase, and the absolute value of the saturation amplitude reflects a state of the DOPO oscillation.

(3) Does the center point of the magnetic field deviate (for example, a bias deviation of a modulator)?

The bias on the horizontal axis reflects the bias at the zero point of the injection pulse phase.

(4) Is there imbalance between positive and negative in the injected magnetic field or the measurement system?

The bias on the vertical axis reflects the imbalance between positive and negative of the amplitudes of the injection pulses, the imbalance between positive and negative of the measurement system, and the like.

These items may be optionally selected to monitor the state of the magnetic field term.

The check bit pattern that may include at least a part of these pieces of information may have various forms, as described in the examples below.

Hereinafter, embodiments of the present invention will be described in detail with reference to the drawings.

### First Example

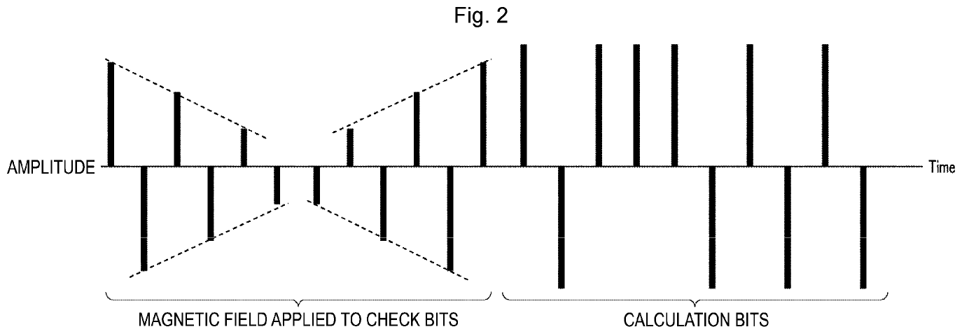

FIG. 2 is a diagram illustrating a pattern of amplitudes of pulses including state monitoring check bits according to a first example. In FIG. 2, the horizontal axis expresses time, time slots are set in the order of circulating light pulses, and sections of both the check bits and the calculation bits are illustrated, and the vertical axis expresses the amplitudes of pulses in which, for example, the optical phase 0 is positive and π is negative. Here, a case of a magnetic field in which the pulses of even-numbered slots have a negative slope, and the pulses of odd-numbered slots have a positive slope is illustrated.

The slopes of the pulses indicate an increasing or a decreasing trend of the amplitude values of the pulses when the time slot number increases (time slot dependence), and the check bit section on the left side in FIG. 2 corresponds to the slopes indicated by dotted lines connecting the leading ends of the pulses in the even-numbered or odd-numbered time slots.

It is important to alternate the magnetic field in the order of the even/odd numbers of the time slots so that this slope and the amplitude of the magnetic field changes from positive to negative or from negative to positive. A feedback signal for the check bits may be proportional to the absolute value of the measured amplitude (fᵢ=Bᵢ|Cᵢ|).

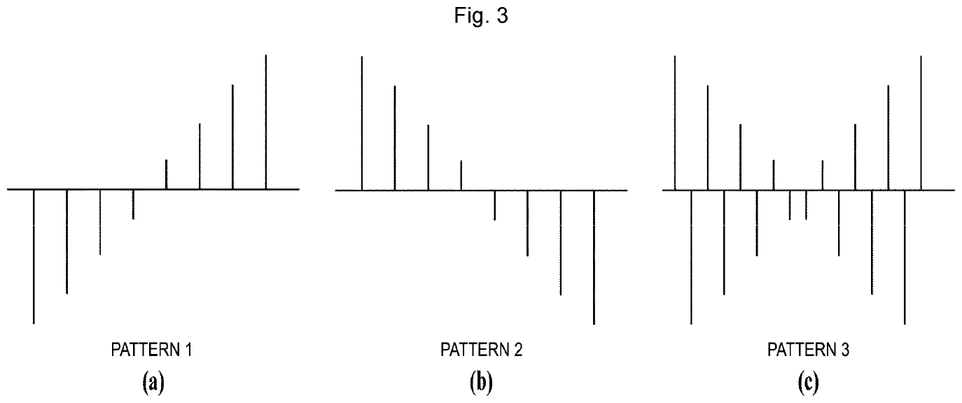

FIGS. 3(a) to 3(c) illustrate other patterns 1 to 3 of pulses of the state monitoring check bits according to the first example. Only portions of the state monitoring check bits are illustrated, and portions of the calculation bits are not illustrated. All of these patterns can be used to check whether the external magnetic field is applied as desired by confirming the above items (1) to (4) of the fitting parameters by a fitting function method described below. Either of the patterns may be assigned to odd-numbered slots or even-numbered slots.

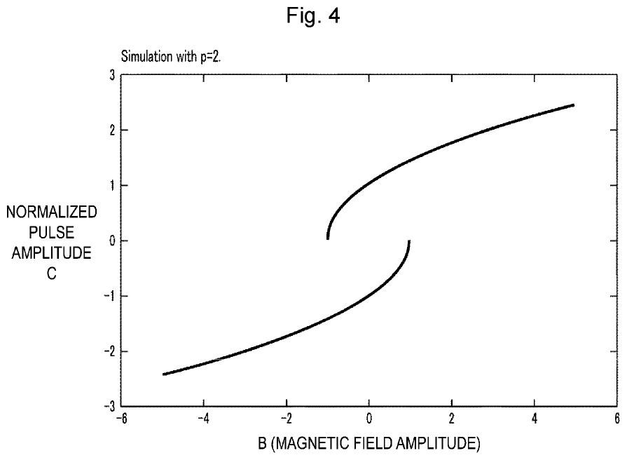

FIG. 4 is a diagram for explaining a steady-state solution of amplitudes of DOPO light pulses including a magnetic field (in a case where a magnetic field term is proportional to the absolute value of the amplitude) and illustrates a relationship between a magnetic field amplitude B (horizontal axis) and a normalized pulse amplitude C (vertical axis).

According to NPL 2, an equation describing the time evolution of the normalized amplitude of the DOPO light pulse is expressed by Equation (8) below.

$$\frac{d}{dt} {c}_{j} = [ - 1 + p - ( {c}_{j}^{2} + {s}_{j}^{2} ) ] {c}_{j} + {\sum }_{l = 1 , l \neq j}^{N} {ξ}_{jl} {c}_{l} \qquad ( 8 )$$

If Equation (8) is simplified to determine a steady-state solution,

For c>0

c=\sqrt{−1+p+B}

For c<0

c=−\sqrt{−1+p−B}

is obtained and the diagram of the relationship between the magnetic field amplitude B and the normalized pulse amplitude C in FIG. 4 is obtained.

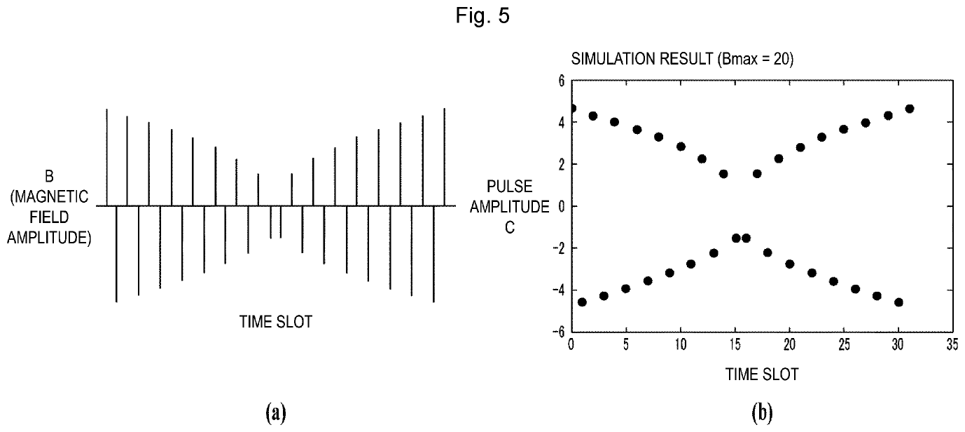

Consequently, if state monitoring check bits of a magnetic field term having the magnetic field amplitude B illustrated in FIG. 5(a) (32 pulses in total, even-numbered pulses having a negative slope, and odd-numbered pulses having a positive slope) are used as input, a simulation result as illustrated in FIG. 5(b) can be obtained.

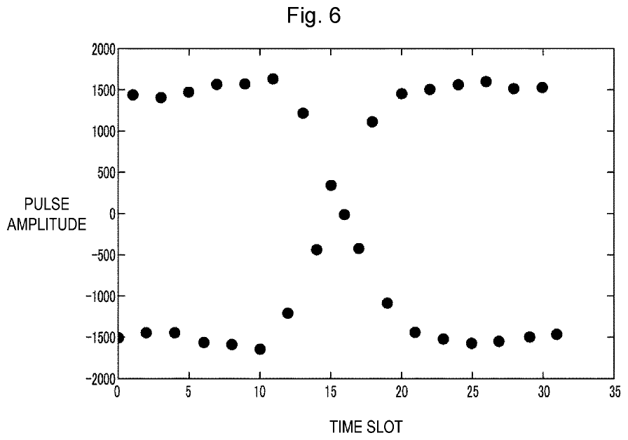

FIG. 6 illustrates an example (experimental results) of a measurement result of amplitudes of actual magnetic field check bits.

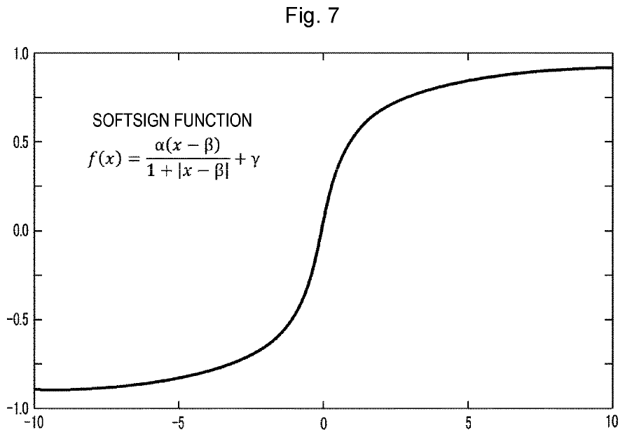

The fitting function illustrated in FIG. 7 according to a second example described below (an example of a Softsign function is illustrated as the fitting function in FIG. 7) is applied and fitted to measurement points of the experimental results to determine fitting parameters (α, β, and γ in FIG. 7). Thus, it is possible to evaluate whether the magnetic field term is applied to a desired state in a generalized Ising model calculation device.

It is noted that the Softsign function is an example, and any function corresponding to a function (activation function) described in NPL 3 can be applied as the fitting function.

### Second Example

The following information can be obtained from the fitting parameters determined by the fitting function of the second example illustrated in FIG. 7.

For example, if the fitting function illustrated in FIG. 7 is fitted to experimental data of an amplitude measurement of even-numbered and odd-numbered magnetic field check bits to determine the fitting parameters α, β, and γ, the following information can be obtained.

The fitting parameters α, β, and γ respectively reflect the following items. α: Saturation amplitude→ The sign of α reflects the sign of the injection pulse phase, and the absolute value of a reflects the state of the DOPO oscillation.

Consequently, it is possible to confirm
whether the orientation (sign) of the phase of the magnetic field is correct (fitting parameter α), and
how much the phase of the magnetic field deviates from 0/π (fitting parameter α). β: Bias on the horizontal axis→β reflects the bias at the zero point of the injection pulse phase.

Consequently,
whether the center point of the magnetic field deviates (for example, a bias deviation of the modulator) (fitting parameter β)
can be confirmed.
γ: Bias on the vertical axis→γ reflects the imbalance between positive and negative of the amplitude of the injection pulse, the imbalance between positive and negative of the measurement system, and the like.

Consequently,
whether there is imbalance between positive and negative in the injected magnetic field or the measurement system (fitting parameter γ) can be confirmed.

These items may be optionally selected to monitor the state of the magnetic field term.

### Third Example

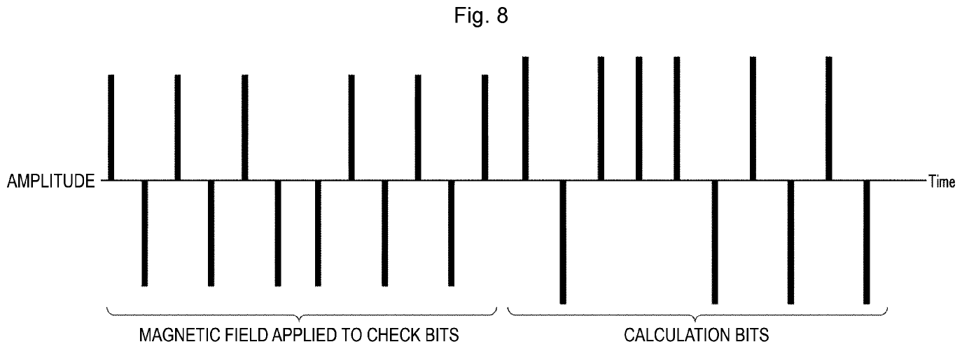

FIG. 8 is a diagram illustrating a pattern of state monitoring check bits according to a third example. In FIG. 8, the left half illustrates a check bit section, and the right half illustrates a calculation bit section.

The check bit pattern that may include at least a part of the pieces of information described in the second example may have various forms. The state monitoring check bits of the third example in FIG. 8 are characterized in that a constant magnetic field is applied to the check bits.

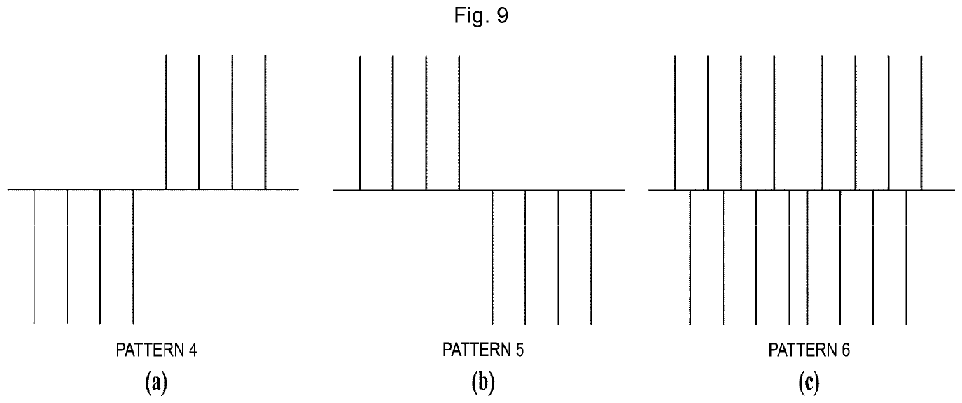

The feedback signal for the check bits may be a constant (fᵢ=Bᵢ). FIGS. 9(a), 9(b), and 9(c) illustrate other patterns 4, 5, and 6 of the state monitoring check bits according to the third example. Pattern 6 in FIG. 9(c) is a combination of patterns 4 and 5 in FIGS. 9(a) and 9(b).

In this case, it is possible to determine that
if the sign of the magnetic field check bit portion is correct, both positive and negative orientations of the phase of the magnetic field are OK (acquisition of information about item (1) of the fitting parameter),
if the amplitude exceeds a certain value, phase shift is OK (acquisition of information about item (2) of the fitting parameter),
it is not possible to obtain information about item (3) of the fitting parameter, and
if there is imbalance between positive and negative of the signal or the measurement system, heights of the positive portion and the negative portion are different. (acquisition of information about item (4) of the fitting parameter).

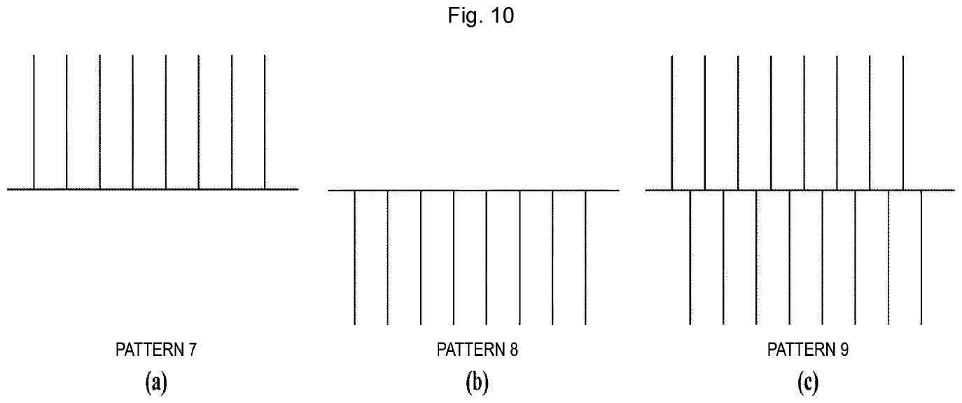

These items may be optionally selected to monitor the state of the magnetic field term. FIGS. 10(a), 10(b), and 10(c) illustrate still other patterns 7, 8, and 9 of the state monitoring check bits according to the third example. Pattern 9 in FIG. 10(c) is a combination of patterns 7 and 8 in FIGS. 10(a) and 10(b) in even-numbered slots and odd-numbered slots.

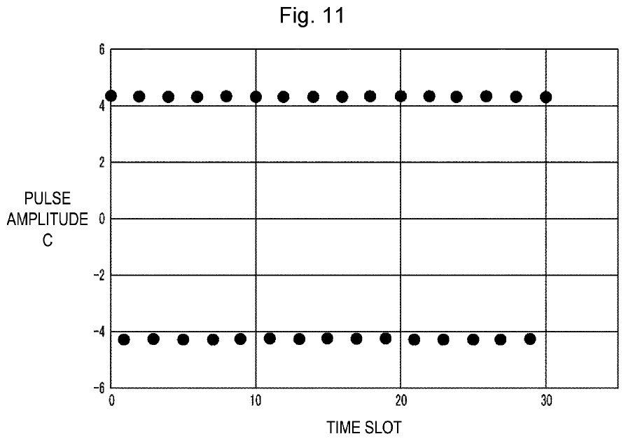

In FIG. 11, the pattern 9 of FIG. 10(c) is expressed as the pulse amplitude C with respect to the time slots on the horizontal axis.

In this case, it is possible to determine that
if the sign of the magnetic field check bit portion is correct, both positive and negative orientations of the magnetic field are OK (acquisition of information about item (1) of the fitting parameter),
if the amplitude exceeds a certain value, phase shift is OK (acquisition of information about item (2) of the fitting parameter), and
it is not possible to obtain information about item (3) of the fitting parameter.
in the case of pattern 9, if there is imbalance between positive and negative of the signal or the measurement system, heights of the positive portion and the negative portion are different. (acquisition of information about item (4) of the fitting parameter). These items may be optionally selected to monitor the state of the magnetic field term.

### INDUSTRIAL APPLICABILITY

As described above, in the present invention, it is possible to implement, in a generalized Ising model composed of a magnetic field term and an inter-spin interaction term, an Ising model calculation device capable of monitoring a state of the magnetic field term and checking the accuracy of a solution.

1. An Ising model calculation device for computing a generalized Ising model expressed by a Hamiltonian having a magnetic field term, the Ising model calculation device configured to:
apply a magnetic field to spins of state monitoring light pulses;
measure amplitudes of the obtained state monitoring light pulses to monitor a state of the magnetic field term; and
monitor an operation state of the Ising model calculation device as a coherent Ising machine.

2. The Ising model calculation device according to claim 1, wherein
the magnetic field applied to the state monitoring light pulses is a magnetic field having amplitude values forming a slope dependent on time slots, and the magnetic field is applied to cross a zero point of the magnetic field.

3. The Ising model calculation device according to claim 1, wherein
the magnetic field applied to the state monitoring light pulses is constant value.

4. The Ising model calculation device according to claim 1, wherein
the magnetic field applied to the state monitoring light pulses is proportional to an absolute value of measured amplitudes of the state monitoring light pulses.

5. The Ising model calculation device according to claim 1, further configured to:
fit a specific fitting function to the measured amplitudes of the state monitoring light pulses; and
using an obtained value of a fitting parameter, select a calculation result of the Ising model calculation device as a coherent Ising machine.

6. The Ising model calculation device according to claim 1, further configured to:
determine an average amplitude value of the measured amplitudes of the state monitoring light pulses; and
using the average amplitude value, select a calculation result of the Ising model calculation device as a coherent Ising machine.

7. (canceled)
